(19) United States
(12) Patent Application Publication
(10) Pub. No.: US 2025/0362276 A1
(43) Pub. Date: Nov. 27, 2025

(54) ANALYTICAL DEVICE WITH SOLVENT-INFORMATION EVALUATION

(71) Applicant: Agilent Technologies, Inc., Santa Clara, CA (US)

(72) Inventors: Christian Haas, Waldbronn (DE); Stephan Buckenmaier, Ettlingen (DE)

(21) Appl. No.: 19/213,425

(22) Filed: May 20, 2025

(30) Foreign Application Priority Data
May 22, 2024 (GB) 2407287.8

(51) Int. Cl. G01N 30/32; G01N 30/02; G01N 30/06; G01N 30/38

(52) U.S. Cl. CPC G01N 30/32; G01N 30/06; G01N 30/38; G01N 2030/027; G01N 2030/322; G01N 2030/326; G01N 2030/328

(57) ABSTRACT

An analytical device, in particular for analyzing a fluidic sample, includes a fluid drive configured to stream a first solvent and a second solvent along a flow path, so that the first solvent and the second solvent are streamed as a mixture at least during a time period. A determination device is configured to determine a value of a physical parameter with respect to the streaming of the mixture along the flow path, for at least two measurements each with a different mixing ratio of the first solvent and the second solvent, thereby determining at least two measurement results. An evaluation device is configured to compare the at least two determined measurement results with a reference, and to derive an information associated with the first solvent and/or the second solvent based on the comparison.

### CROSS-REFERENCE TO RELATED APPLICATIONS

The present application claims the benefit of UK Patent Application No. GB 2407287.8, filed on May 22, 2024, which is incorporated herein by reference in its entirety.

### TECHNICAL FIELD

The present disclosure relates to an analytical device with a fluid drive, configured to stream a first solvent and a second solvent along a flow path, so that the first solvent and the second solvent are streamed as a mixture at least during a time period. Further, the analytical device includes a determination device, such as a sensor, to determine as measurement results a value of a physical parameter for different ratios of the solvent mixture, and an evaluation device to derive solvent-associated information based of the determined measurement results by comparing the measurement results with a reference. Further, the present disclosure relates to an analytical system and a method of deriving solvent-associated information.

### BACKGROUND

Analytical devices are provided for analyzing a sample, for example, using a sample separation device.

For example, for liquid separation in a chromatography system, a mobile phase comprising a sample fluid (e.g., a chemical or biological mixture) with compounds to be separated is driven through a stationary phase (such as a chromatographic column packing), thus separating different compounds of the sample fluid, which may then be identified.

The mobile phase, typically comprised of one or more solvents, is pumped under high pressure typically through a chromatographic column containing packing medium (also referred to as packing material or stationary phase). As the sample is carried through the column by the liquid flow, the different compounds, each one having a different affinity to the packing medium, move through the column at different speeds. Those compounds having greater affinity for the stationary phase move more slowly through the column than those having less affinity, and this speed differential results in the compounds being separated from one another as they pass through the column. The stationary phase is subject to a mechanical force generated in particular by a hydraulic pump that pumps the mobile phase usually from an upstream connection of the column to a downstream connection of the column. As a result of flow, depending on the physical properties of the stationary phase and the mobile phase, a relatively high pressure drop is generated across the column.

Solvents for an analytical device are generally stored in solvent containers/bottles, in case of an HPLC normally placed on top of the instrument. By means of solvent channels (configured like a hose), the solvent containers are connected to one or more fluid drives of the analytical instrument with the capability of mixing the solvents. The fluid drive pumps the solvent(s) from the solvent containers to the analytical portion, e.g., a sample separation device/column.

In modern HPLC, a plurality of different solvents and solvent mixtures is applied. Thus, a corresponding plurality of solvent containers can be present and a plurality of solvent channels can connect these solvent containers to the rest of the analytical instrument. The high number of solvent containers/channels may become easily confusing for an operator.

Typically, the operator is required to set solvent parameters for an analysis, e.g., using a solvent table that stores the required solvent parameters for the most common solvents. This process is labor-some and error-prone, especially, when many solvents are applied and/or when solvents are often exchanged. The organization of solvents is yet very important in the context of analytical devices. It should be kept in mind that using a wrong solvent would result in distorted analysis results.

There are solutions for the determination of parameters such as solvent compressibility or the solvent thermal expansion coefficient. However, these approaches typically require additional sensors that increase the costs and the complexity of the system.

### SUMMARY

There may be a need to derive solvent-associated information for an analytical device in an efficient and reliable manner.

According to an aspect of the disclosure, there is described an analytical device (e.g., a HPLC), in particular for analyzing a fluidic sample, wherein the analytical device comprises:
i) a fluid drive (e.g., an analytical pump), configured to stream a first solvent (e.g., water) and a second solvent (e.g., acetonitrile) along a flow path (e.g., from the fluid drive to a sample separation device), so that the first solvent and the second solvent are streamed as a mixture (with a specific ratio) at least during a time period (for example, only solvent A will be streamed in the first place and then the concentration of solvent B is continuously increased).
ii) a determination device (e.g., a pressure sensor), configured to determine a value of a physical parameter (e.g., pressure) (in other words: configured to determine a parameter indicative of a property, in particular a physical property, of the mixture) with respect to the streaming of the mixture along the flow path for at least two measurements each with a different mixing ratio of the first solvent and the second solvent, thereby determining at least two measurement results (in particular a plurality of measurement points that form a measurement curve, see, e.g., FIG. 4).
iii) an evaluation device (e.g., a processor, a computer, a control device, etc.), configured to compare the at least two determined measurement results with a reference (e.g., a database) and to derive an information (e.g., a verification, an identification, an assignment) associated with the first solvent and/or the second solvent based on the comparison (e.g., by comparing a measured curve with a reference curve, a specific solvent mixture and therewith the types of the solvents can be identified).

According to a further aspect of the disclosure, there is described an analytical system, comprising: i) an analytical device as described above, and ii) a database, wherein the analytical device and the database are communicatively coupled, in particular via a network.

According to a further aspect of the disclosure, there is described a method for deriving solvent-associated information for an analytical device, the method comprising: i) streaming a first solvent and a second solvent along a flow path, hereby streaming the first solvent and the second solvent as a mixture at least during a time period, ii) determining a value of a physical parameter with respect to the streaming of the mixture along the flow path for at least two measurements each with a different mixing ratio of the first solvent and the second solvent, thereby determining at least two measurement results, iii) comparing the at least two determined measurement results, in particular as a measurement curve, with a reference, and iv) deriving the solvent-associated information based on the comparison.

In the context of this document, the term “determination device” may particularly denote a device configured to determine (experimentally measure) a value of a physical parameter. The physical parameters may be a physical parameter of the mixture or may be indicative of a property (in particular a physical property) of the mixture (a parameter with respect to the streaming of the mixture). A physical parameter of the mixture may be, for example, a density or a viscosity. A physical parameter indicative of a property of the mixture may be, for example, a pressure or a flow rate. In an example, the physical parameter of the mixture may be determined based on one or more physical parameters indicative of a property of the mixture; for example, viscosity of the mixture may be determined based on measuring a pressure and a flow rate.

The physical parameter may be measured for different ratios of a solvent mixture. The determination device may be realized as a sensor device such as a pressure sensor, flow rate sensor, etc. In an embodiment, a sensor device already present in the analytical device (such as the pressure sensor of the analytical pump) may be used as the determination device.

In the context of this document, the term “evaluation device” may particularly denote a device configured to evaluate (analyze) the measurement results from the determination device, in particular by comparing the results with a reference, such as reference data in a database. The evaluation device may be realized as a processor, a computer, a part of the analytical device control software (control device), a remote functionality, etc. In an example, the evaluation device may align/overlay the measured data (e.g., a curve/profile) with the reference data, thereby searching for the best match. A plurality of algorithms is known to the skilled person to perform such a comparison of data. Such an algorithm may be supported by artificial intelligence in an example. Based on the comparison (e.g., a match between the measured data and reference data with known solvents), the solvents of the mixture may be identified/verified (in other words: the solvent-associated information is derived).

In the context of this document, the term “mixture” may particularly denote a mixture of two or more solvents. For example, the typical HPLC solvents water, methanol and/or acetonitrile may be mixed in a specific ratio, for example water/acetonitrile 80:20, thereby obtaining a first solvent mixture. In a further example, the ratio may be changed, for example, to water/acetonitrile 50:50, thereby obtaining a second solvent mixture. The change in the ratio may be done step-wise/discontinuously or continuously.

In the context of this document, the term “mobile phase” may particularly denote any liquid and/or fluidic, e.g. super-critical, medium that may serve as fluidic carrier of the fluidic sample during separation. A mobile phase may be a solvent or a solvent composition (for instance composed of water and an organic solvent such as ethanol or acetonitrile). In an isocratic separation mode of a liquid chromatography apparatus, the mobile phase may have a constant composition over time. In a gradient mode, however, the composition of the mobile phase may be changed over time, in particular to desorb fractions of the fluidic sample that have previously been adsorbed to a stationary phase of a separation unit.

In the context of the present document, the term “analytical device” may in particular refer to a device suitable to perform an analysis of a sample. In an example, the analytical device is applied to analyze (characterize) a sample-by-sample separation (such as chromatography). In the context of the present document, the term “chromatography device” may in particular refer to an instrument suitable to perform a chromatographic analysis, for analyzing a sample, such as for carrying out a chromatographic separation of the sample. Examples of an analytical device may include a liquid chromatography (LC) instrument, in particular a high-performance liquid chromatography (HPLC) instrument or an ultra-high-performance liquid chromatography (UHPLC) instrument, a multi-dimensional LC instrument, in particular a 2D-LC device, an online LC instrument, an LC-MS apparatus, a supercritical fluid chromatography device, an electrophoresis system, or a microfluidic device. In an embodiment, the analytical device comprising an (optical) detection device coupled to or couplable/connectable to a source of pressure.

In the context of this document, the term “sample separation device” may particularly denote any apparatus that is capable of separating different fractions of a fluidic sample by applying a certain separation technique, in particular liquid chromatography.

The term “sample separation unit” may particularly denote a fluidic member through which a fluidic sample is transferred and which is configured so that, upon conducting the fluidic sample through the separation unit, the fluidic sample will be separated into different groups of molecules or particles according to their properties. An example for a separation unit is a liquid chromatography column that is capable of trapping or retarding and selectively releasing different fractions of the fluidic sample.

The term “flow path” may be understood in this context as a fluidic path engaged (in a present switching and configuration state of the sample separation device) in fluid transport, e.g., from a fluid drive to a sample separation unit.

In the context of this document, the term “fluidic sample” may particularly denote any liquid and/or gaseous medium, optionally including also solid particles, which is to be analyzed. Such a fluidic sample may comprise a plurality of fractions of molecules or particles that shall be separated, for instance small mass molecules or large mass biomolecules such as proteins. Separation of a fluidic sample into fractions involves a certain separation criterion (such as molecular mass or volume, chemical properties, etc.) according to which a separation is carried out.

According to an exemplary embodiment, the disclosure may be based on the idea that solvent-associated information for an analytical device can be derived in an efficient and reliable manner, when a value of a physical parameter (such as pressure) is measured for at least two different solvent mixture ratios (e.g., 25:75, 50:50, 75:25), and the measurement result is then compared to a reference, thereby identifying/verifying the solvent (solvent pair/combination of the mixture).

While conventional methods apply additional sensors to determine absolute parameters of (related to) the solvent (composition), the present disclosure presents a new approach by determining a relative variation in a physical parameter (e.g., viscosity or density) in response to mixing solvents in different ratios. The obtained relative measurement results can be used as fingerprints and compared with reference data. Thereby, the solvents (of the mixture), in particular a specific solvent pair, may be identified/verified.

The disclosure may further enable a concept on how to determine which solvents are connected to the different channels of the pump, or at least check if the solvents according to an analysis method to be performed are correct. In an embodiment, no additional hardware, such as sensors, is required.

In a specific example, a restriction element (e.g., a capillary, a column, a backpressure regulator) is integrated in the flow path, e.g., prior to the chromatographic column or in a side path (which can be switched into the flow path, e.g. using a valve), to run back-pressure experiments with different solvent compositions (mixture ratios). These back-pressure data are analyzed and compared against a database containing data and/or models. The comparison may be used to determine the solvents used or to verify the given solvents in the respective channels.

### EXEMPLARY EMBODIMENTS

In an embodiment, the mixture changes during the time period continuously or discontinuously. In an embodiment, a gradient (gradient mode) or no gradient (isocratic mode) is applied (by the analytical device). This may provide the advantage that an already present operation mode/configuration can be applied for providing different solvent mixture ratios in an efficient and reliable manner. The determination/validation of the solvent(s) can be done, for example, by running a continuous gradient, a step gradient, or even by selective changes (no gradient) of the solvent composition.

In an embodiment, a first measurement result is determined with respect to a first mixture (AB) of the first solvent and the second solvent, a second measurement result is determined with respect to a second mixture of the first solvent and the second solvent, and the first mixture (AB) is different from the second mixture.

In an embodiment, the reference comprises a database (e.g., stored in a control device of the analytical device or being established remotely), and wherein the evaluation device is configured to compare the determined measurement results with the database. This may provide the advantage that the measured results (e.g., a characteristic profile) can be evaluated in a reliable manner. In other words: a fingerprint method is applied, identifying a measured characteristic solvent pair with reference measurements. The data in the database can be experimentally determined and/or theoretical (e.g., empiric, calculated, modelled, etc.).

In an embodiment, the system configuration of the analytical device and the system configuration of the reference is (at least partially) comparable, in particular similar. For example, a restriction element may be applied in a comparable/similar manner in the analytical device and the reference.

In a specific example, the reference data for the measurement (pressure) curves were collected with a specific system configuration, i.e. with a certain restriction element. The analytical device applied may eventually have a different system configuration, e.g., different restriction element. Accordingly, the comparison of the measured result with the reference data may be carried out by comparing specific patterns/curve features (e.g., curve pitch, local maxima or minima, slopes, turning points, etc.), i.e. relatively, not absolutely. In an embodiment, the comparison comprises a pattern recognition.

In an example, the restriction element may be adjusted for most systems, e.g., by switching between a main pass and a by-pass flow path, switching between different column positions, etc. It might be straightforward for the evaluation, if the restriction element of the current analytic device is as close as possible to the system with which the reference data has been determined.

In an embodiment, there can be a further step in which the system configuration (for example, with respect to the restriction (element)) of the current analytic device is aligned with (adjusted to) the system configuration (in particular regarding the reference restriction (element)) (as much as possible). Thereby, the reliability of the solvent evaluation may be improved.

In an embodiment, the comparison of the determined measurement results and the reference is done in a relative manner. This may provide the advantage that the comparison may be made (at least partially) independent from (specific) system configurations, thereby being more flexible. For example, specific properties of the measurement results and the reference may be compared, e.g. curve shapes, local maxima, local minima, slopes, turning points, pitch, etc. In an example, the measurement results may reflect a specific pattern/characteristic (fingerprint) that may be (partially) independent of system configurations.

In an embodiment, the physical parameter is at least one of a pressure, a flow rate, a flow volume, a conductivity, a temperature, a compressibility, a viscosity, a density, a refractive index, a heat capacity, a light absorption coefficient. Thus, common (and important) parameters of an analytic device may be directly used/measured to characterize the different solvent mixture ratios. While physical parameters such as density or viscosity may be parameters of the mixture, physical parameters such as pressure or flow rate may be seen as physical parameters indicative of a property of the mixture. Based on such a physical parameter indicative of a property of the mixture, a physical parameter of the mixture may be determined; for example, the density may be calculated based on a measured pressure.

In an embodiment, the determination device is a measurement device, e.g. a sensor device. In an embodiment, the determination device is configured as at least one of a pressure sensor (in particular of the fluid drive), a flow sensor, a temperature sensor, a conductivity sensor, a photodetector. Hence, an already existing sensor device of the analytic device may be directly applied for the solvent-associated information determination. Thereby, costs, space, and efforts can be saved. An analytic instrument like a HPLC may be a highly sophisticated device that requires a plurality of sensors in order to keep all relevant functionalities at a high performance. The presence of these sensors may be directly exploited for a reliable determination of physical parameters regarding the solvent mixture ratios.

In an embodiment, the analytical device comprises a restriction and/or a restriction element, arranged at least partially in the flow path. In an embodiment, the restriction (element) is configured to restrict the fluid stream in the flow path, thereby generating a back pressure.

In the present context, the term “restriction element” may refer to a portion of a flow path that causes a restriction to the streaming fluid of the flow path. For example, a restriction element may be part of a channel/conduit/capillary that is more narrow than other parts. The presence alone of this narrow portion may function as a restriction that generates a back-pressure. In another example, the restriction element may be an additional element in a flow path, configured to restrict the flow, e.g. a loop.

In an embodiment, the restriction element is configured as a part of the flow path. In an embodiment, the restriction element is configured as an additional element. Depending on the desired functionality/application, there are different advantageous options of how to design the restriction element.

In an embodiment, the restriction element is configured as at least one of a capillary, a channel, a conduit, a loop, a column. These are merely examples of how to implement a restriction in a flow path. Depending on the present circumstances, one or more of these examples may be preferable.

In an embodiment, the restriction element is arranged at a main flow path or at a bypass flow path. A restriction in the main pass (e.g., from fluid drive via sampler/injector to column) may enable the solvent information determination directly during operation (in the main configuration) of the analytic device. A restriction element in a bypass flow path (e.g., connected to the purge valve like in FIG. 2) may enable a selective configuration for the solvent information determination besides the main pass configuration (like a special operation mode).

In an embodiment, the restriction element is arranged upstream of a/the sample separation unit (chromatographic column). This may provide the advantage that the solvent information determination can be done in the (main/bypass) flow path before the mobile phase becomes subject of a separation process.

In an embodiment, the restriction element is associated with at least one of a valve, in particular a purge valve, a sample injector, a sample, loop, an oven, the (whole) analytic path. In an example, the restriction element may be a part of at least one of these examples. In another example, the restriction element may be implemented in a bypass configuration associated with at least one of these examples (e.g., a restriction element in a bypass coupled to the purge valve like in FIG. 2).

In an embodiment, the restriction element is adjustable, in particular by switching to a specific flow path. For example, switching from the main pass configuration to a bypass configuration (as discussed above) may enable a special operation mode to determine the solvent information. Thereby, disturbance by the main pass flow may be reduced/eliminated.

In an embodiment, the analytical device further comprises a mixture portion (e.g. (switching/mixing) valve), configured to mix the first solvent and the second solvent. Thus, an already present device may be directly applied to provide the desired solvent mixture ratio. There is a plurality of established types of mixers and mixing points. For example, the mixture can be done actively via a proportioning valve in the low-pressure path (see FIG. 2). Alternatively, a mixture can be carried out in the high-pressure path, in which (at least) two parallel pumps each pump a solvent, which are then mixed downstream. In an example, the mixing point itself can be a complex mixer like Agilent's Jet Weaver or a simple T-connector.

In an embodiment, the at least two measurement results are measurement points that form (part of) a measurement curve (profile). In an embodiment, the comparison comprises: comparing the measurement curve with a reference curve (e.g., stored in the database). The measurements of a specific value of a physical parameter for different mixture ratios may result in a characteristic pattern that may be used as a fingerprint for a specific solvent pair (see, e.g., FIG. 4). Depending on the system parameters (e.g., temperature, etc.), different patterns may be obtained, so that the measurement result may also reflect the system parameters. Comparing such patterns (in particular curves) of mixture ratios may enable a relative comparison, being eventually more flexible and straightforward than an absolute comparison.

In an embodiment, at least one of the first solvent and the second solvent is known. In an embodiment, the first solvent and the second solvent are unknown. The result of the solvent-associated information derivation would normally be an identification/knowledge of both solvents of the applied solvent pair/combination. If one solvent (e.g., water) is already known, the second solvent may be determined more easily. For example, all the curves that were not determined with the one known solvent could then be excluded for comparison, which may lead to a faster or clearer result.

In an example, only one solvent is unknown and should be determined/verified. In this case, another (e.g., known) solvent may be used to form the solvent pair/combination for the mixture ratios, since the described disclosure may refer to a relative determination method.

In an embodiment, the (solvent-associated) information comprises determine/identify/derive the first solvent and/or the second solvent. In an embodiment, the (solvent-associated) information comprises verify the first solvent and/or the second solvent. Generally, both solvents may be identified, since a pairwise identification/verification is done by the comparison.

In an embodiment, the (solvent-associated) information comprises assignment of the first solvent to a first solvent container and/or a first solvent channel. In an embodiment, the (solvent-associated) information comprises assignment of the second solvent to a second solvent container and/or a second solvent channel. Especially in case a plurality of solvents and corresponding containers/channels may be applied, it may be difficult to keep an overview about the individual connections. Thus, an (automatic) assignment may be performed based on solvent mixtures.

In an embodiment, the (solvent-associated) information comprises to verify, if the first solvent is associated with a first solvent container and/or a first solvent channel. In an embodiment, the (solvent-associated) information comprises to verify, if the second solvent is associated with a second solvent container and/or a second solvent channel.

In an embodiment, the analytical device further comprises an analytic portion/domain, in particular a sample separation unit/chromatographic column, configured to analyze the fluidic sample. In an embodiment, the analytical device is configured as a sample separation device, in particular a fluidic chromatography device, more in particular a high-performance liquid chromatography device.

In an embodiment, the database comprises a plurality of solvent mixture data and/or a plurality of solvent mixture models, in particular wherein the database comprises experimental and/or theoretical data (e.g., simulated, modelled; in particular when the system is characterized regarding the restriction element, etc.). Depending on the amount and reliability/accuracy of the information available in the database, the comparison may yield a more precise solvent characterization. Yet, in an example, the comparison may yield merely (but still very useful) an educated guess of the solvents.

In an embodiment, the same flow path is used for the derivation of two or more (solvent-associated) information. In other words, the same (bypass) flow path may be used to derive a plurality of information regarding different solvent combinations.

In an embodiment, the same flow path is used for a plurality of different solvents (A, B, C, D). In principle, the number of solvents to be determined may not be limited, making the disclosure very versatile.

In a specific embodiment, more than two solvents may be mixed in specific ratios. Thereby, a smaller number of measurements may be required in case of several solvents are to be identified/verified. Further, the mixture of three or more solvents may yield quite characteristic measurement results.

In an embodiment, at least one determination device of the analytical device is applied. In an embodiment, the analytical device/method is free of an additional determination device. Thereby, costs, space, and efforts can be saved.

In an embodiment, the sample separation device is configured as a fluidic chromatography device, more in particular a high-performance liquid chromatography, HPLC, device.

In preparative chromatography systems, a liquid as the mobile phase is provided usually at a controlled flow rate (e. g. in the range of 1 mL/min to thousands of mL/min, e.g., in analytical scale preparative LC in the range of 1-5 mL/min and preparative scale in the range of 4-200 mL/min) and at pressure in the range of tens to hundreds bar, e.g. 20-600 bar.

In high-performance liquid chromatography (HPLC), a liquid as the mobile phase has to be provided usually at a very controlled flow rate (e.g., in the range of microliters to milliliters per minute) and at high pressure (typically 20-100 MPa, 200-1000 bar, and beyond up to currently 200 MPa, 2000 bar) at which compressibility of the liquid becomes noticeable.

In analytical devices, specifically in liquid chromatography (in particular HPLC), it may be important to provide an accurate solvent flow, even in the case that specific properties of the solvent are not known or are not downloaded to the control unit of an analytical device.

Embodiments may be implemented in conventionally available HPLC systems, such as the analytical Agilent 1260 Infinity II LC system or the Agilent 1290 Infinity II Preparative LC system (both provided by the applicant Agilent Technologies-see www.agilent.com).

One embodiment of a sample separation apparatus comprises a pump having a pump piston for reciprocation in a pump working chamber to compress liquid in the pump working chamber to a high pressure at which compressibility of the liquid becomes noticeable. This pump or the control unit may be configured to process numeric values of solvent properties (the values being provided to the pump by means of operator's input, notification from another module of the instrument or similar or the pump elsewise derives solvent properties before or during its operation).

The sample separation unit of the sample separation apparatus may comprise a chromatographic column (see for instance http://en.wikipedia.org/wiki/Column_chromatography) comprising a stationary phase. The column may be a glass or steel tube (for instance with a diameter from 50 μm to 5 mm and a length of 1 cm to 1 m) or a microfluidic column (as disclosed for instance in EP 1577012, the entire contents of which are incorporated by reference herein, or the Agilent 1200 Series HPLC-Chip/MS System provided by the applicant Agilent Technologies). The individual components are retained by the stationary phase differently and at least partly separate from each other while they are propagating at different speeds through the column with the eluent. At the end of the column they elute one at a time or at least not entirely simultaneously. During the entire chromatography process the eluent may be also collected in a series of fractions. The stationary phase or adsorbent in column chromatography usually is a solid material. The most common stationary phase for column chromatography is silica gel, surface modified silica gel, followed by alumina. Cellulose powder has often been used in the past. Most common chromatography modes are ion exchange chromatography, reversed-phase chromatography (RP), affinity chromatography or expanded bed adsorption (EBA). The stationary phases are usually fine powders or gels and/or are microporous for an increased surface.

The mobile phase (or eluent) can be a pure solvent or a mixture of different solvents (such as water and an organic solvent such as ACN, acetonitrile). It can be chosen for instance to adjust the retention of the compounds of interest and/or the amount of mobile phase to run the chromatography. The mobile phase can also be chosen so that the different compounds or fractions of the fluidic sample can be separated efficiently. The mobile phase may comprise an organic solvent like for instance methanol or acetonitrile, often diluted with water. For gradient operation, water and organic solvent are stored in and/or delivered from separate containers, from which the gradient pump delivers a programmed blend to the system. Other commonly used solvents may be isopropanol, tetrahydrofuran (THF), hexane, ethanol and/or any combination thereof or any combination of these with afore-mentioned solvents. However, there is no restriction to these solvents.

A fluidic sample analyzed by a sample separation device according to an exemplary embodiment of the disclosure may comprise but is not limited to any type of process liquid, natural sample like juice, body fluids like plasma or it may be the result of a reaction like from a fermentation broth.

The pressure, as generated by the fluid drive, in the mobile phase may range from 2-200 MPa (20 to 2000 bar), in particular 10-150 MPa (150 to 1500 bar), and more particularly 50-120 MPa (500 to 1200 bar).

The sample separation device, for instance an HPLC system, may further comprise a detector for detecting separated compounds of the fluidic sample, a fractionating unit for outputting separated compounds of the fluidic sample, or any combination thereof. For example, a fluorescence detector may be implemented.

In a specific embodiment, it is the aim to determine or verify the respective solvent by analyzing the pressure signal resulting from the conveyance of a time-varying solvent composition (consisting of at least two solvents). In other words, one or more bottles of unknown solvent are installed on the analytical device and a certain gradient of at least two solvents is conveyed. The resulting pressure profile is characteristic of the solvents used for a specific composition, whereby it is not (only) the absolute pressure value that is relevant, but the pressure profile, i.e. the curve. If the same gradient is conveyed with the same solvents in a system with a different restriction, the result is (ideally) the same pressure profile, but with different absolute values. The obtained profile is then compared with a database with various known/previously measured print profiles for common solvent combinations (pattern recognition), whereby the solvents of the known/previously measured profiles are associated with the profiles in the database. From this, one or more unknown solvents can be determined, e.g. water: channel A, acetonitrile: channel B. A determination of the solvent composition would be relevant if unknown solvent mixtures were to be installed on the device.

Embodiments of the present disclosure may be partly or entirely embodied or supported by one or more suitable software programs or products, which may be stored on or otherwise provided by any kind of non-transitory medium or data carrier, and which may be executed in or by any suitable data processing unit such as an electronic processor-based computing device (or system controller, controller, control unit, device or apparatus for data processing, etc.) that includes one or more electronic processors and memories. Software programs or routines (e.g., computer-executable or machine-executable instructions or code) may be applied in or by the control unit, e.g. a data processing system such as a computer, such as for executing any of the methods described herein. For example, one or more embodiments of the present disclosure may provide a non-transitory computer-readable medium that includes instructions stored thereon, such that when executed on a processor, the instructions perform the steps of the method of any of the embodiments disclosed herein.

### BRIEF DESCRIPTION OF DRAWINGS

Other objects and many of the attendant advantages of embodiments of the present disclosure will be readily appreciated and become better understood by reference to the following more detailed description of embodiments in connection with the accompanying drawings. Features that are substantially or functionally equal or similar will be referred to by the same reference signs.

FIG. 1 shows an analytical device configured as a high-performance liquid chromatography (HPLC) system, in accordance with embodiments of the present disclosure.

FIG. 2 shows a detailed view of the analytical device with a restriction element, in accordance with embodiments of the present disclosure.

FIG. 3 shows an analytical system with an analytical device and a database, in accordance with embodiments of the present disclosure.

FIG. 4 shows measurement curves that result from measurement points obtained from different solvent mixture ratios, in accordance with embodiments of the present disclosure.

The illustrations in the drawings are schematic.

### DETAILED DESCRIPTION OF THE DRAWINGS

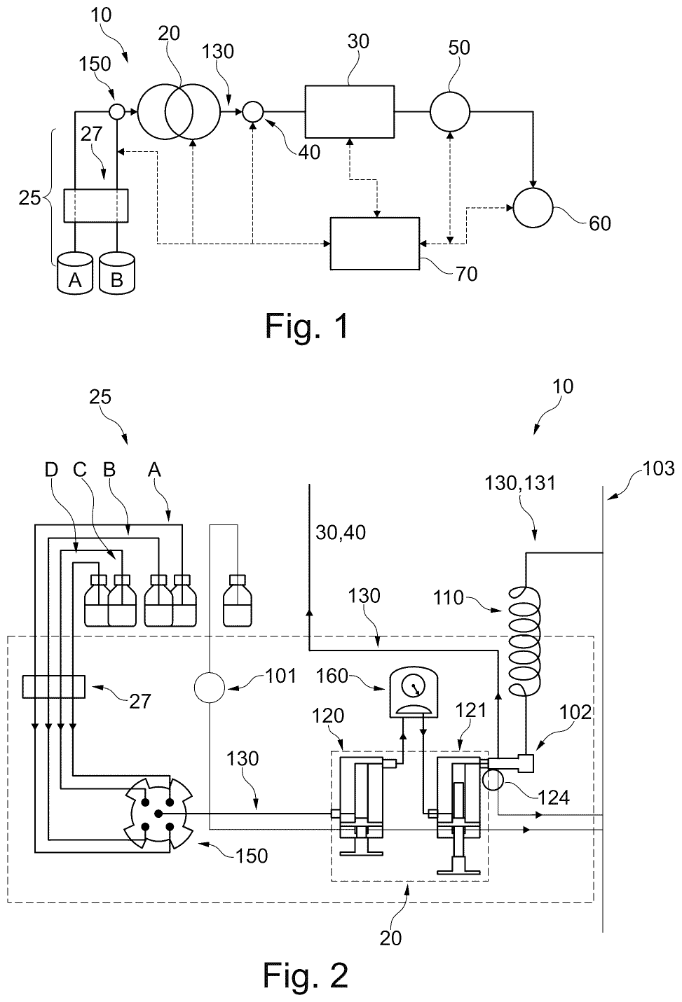

FIG. 1 shows an analytical device 10 configured as a high-performance liquid chromatography (HPLC) system, in accordance with embodiments of the present disclosure. A pump as fluid drive 20 receives a mobile phase from a solvent supply 25, typically via a degasser 27, which degases and thus reduces the amount of dissolved gases in the mobile phase. In this example, two different solvents A and B are used, each stored in a respective solvent container. The mobile phase drive or fluid drive 20 drives the mobile phase through a sample separation unit 30 (such as a chromatographic column) comprising a stationary phase. A sampler or injector 40, comprising a fluidic valve, can be provided between the fluid drive 20 and the separation unit 30 in order to subject or add (often referred to as sample introduction) a sample fluid into the mobile phase. The stationary phase of the separation unit 30 is configured for separating compounds of the sample liquid. A detector 50 is provided for detecting separated compounds of the sample fluid. A fractionating unit 60 can be provided for outputting separated compounds of sample fluid.

While the mobile phase can comprise one solvent only, it may also be mixed from plural solvents. The corresponding mixing process might be a low-pressure mixing and provided upstream of the fluid drive 20 in mixing valve 150, so that the fluid drive 20 already receives and pumps the mixed solvents as the mobile phase. Alternatively, the fluid drive 20 may comprise plural individual pumping units or fluid drive units, each receiving and pumping a different solvent or mixture, so that the mixing of the mobile phase (as received by the separation unit 30) occurs at the high-pressure side and downstream of the fluid drive 20 (or as part thereof). The composition (mixture) of the mobile phase may be kept constant over time, the so-called isocratic mode, or varied over time, the so-called gradient mode.

A data processing unit or control device/unit 70 (which can be a PC or workstation, alternatively it can be also a dedicated controller as a hand-held controller, or a processing unit such as microcontroller, microprocessor or plurality of those operating in coordinated manner or at least interacting, contained in or being part of one or more of the system modules 25, 27, 20, 30, 50, 60) may be coupled (as indicated by the dotted arrows) to one or more of the devices in the analytical device 10 in order to receive information and/or control operation. For example, the control device 70 may control operation of the fluid drive 20 (for example, setting control parameters) and receive therefrom information regarding the actual working conditions (such as output pressure, etc. at an outlet of the pump 20). The control device 70 may also control operation of the solvent supply 25 (for example, setting the solvent/s or solvent mixture to be supplied) and/or the degasser 27 (for example, setting control parameters such as vacuum level) and might receive therefrom information regarding the actual working conditions (such as solvent composition supplied over time, vacuum level, etc.). The control device 70 might further control operation of the sampler or injector 40 (for example, controlling sample injection or synchronization of sample injection with operating conditions of the fluid drive 20).

The separation unit 30 might also be controlled by the control device 70 (for example, selecting a specific flow path or column, setting operation temperature, etc.), and send-in return-information (for example, operating conditions) to the control device 70. Accordingly, the detector 50 might be controlled by the control device 70 (for example, with respect to spectral or wavelength settings, setting time constants, start/stop data acquisition, etc.), and send information (for example, about the detected sample compounds) to the control device 70. The control device 70 might also control operation of the fractionating unit 60 (for example, in conjunction with data received from the detector 50), which provides data back.

FIG. 2 shows a detailed view of the analytical device 10 with a restriction element 110, in accordance with embodiments of the present disclosure. As described for FIG. 1, a plurality of solvent containers (here four different solvents: A-D) are connected by respective solvent channels (A-D), via a degasser 27, to a mixing valve 150 of the analytical device 10. By means of the mixing valve 150, a specific solvent mixture ratio can be adjusted.

The fluid drive 20 comprises in this example two pump units 120, 121, each with a respective piston and piston chamber (dual pump). The two pump units 120, 121 are fluidically coupled to enable a continuous fluid flow and comprise a damper 160 for eliminating pressure ripples. The fluid drive 20 is configured to draw solvent from the solvent containers A-D and to stream the solvent (mixture) as a mobile phase (via the sample injector 40) towards the sample separation unit 30 in a flow path 130. This flow path 130 can be considered as the principal (main) pass within the analytical device 10. It can be seen that there are further minor flow paths that lead to wash pump 101 and waste line 103.

Furthermore, the fluid drive 20 is fluidically connected/connectable to a purge valve 102. By switching the fluid drive 20 to the purge valve 102 (a bypass configuration), mobile phase can be streamed from the fluid drive 20 to waste (via waste line 103), thereby cleaning the system.

In the present example, the purge valve 102 (automatic or manual) has an additional port that leads to the waste line 103, whereby the restriction element 110 is arranged in this bypass flow path 131. When the solvent-associated information is to be derived, the fluid drive 20 can be switched in the bypass configuration that leads to the bypass flow path 131 through the restriction element 110. The restriction element 110 is configured here as a loop that generates a mixture-characteristic back-pressure, which can then be measured by a determination device 124, e.g., the already present pump pressure sensor.

In other words, a specific bypass configuration can be selected to provide the restriction element 110 to the flow path, thereby generating a back-pressure to be measured. The back-pressure measurement enhances the differences regarding the value of the physical parameter for different solvent mixture ratios in comparison to mere pressure measurements.

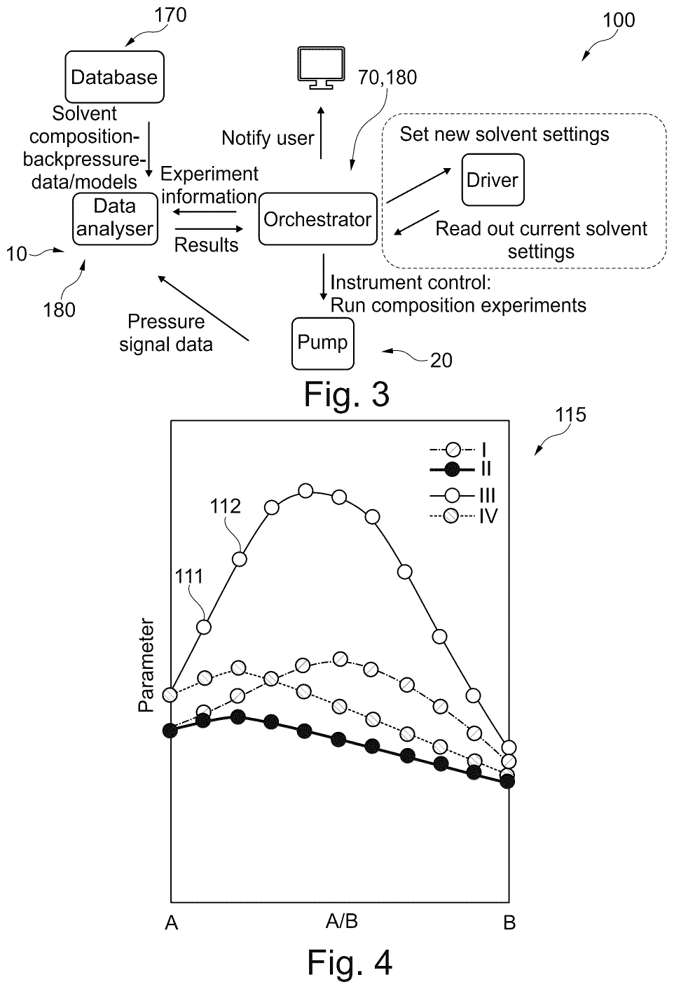

FIG. 3 shows an analytical system 100 with an analytical device 10 and a database 170, in accordance with embodiments of the present disclosure. The analytical device 10 comprises in this example the control device 70 (here called “orchestrator”) to organize deriving the solvent-associated information. The control device 70 controls the fluid drive 20 to stream the solvent (mixture) in a specific manner. Further, the control device 70 functions as a user interface, notifying the operator. A (already present) pressure sensor of the fluid drive 20 (e.g., determination device 124) is used to measure the value of the physical parameter “pressure” for different solvent mixture ratios, thereby providing pressure signal data as measurement results.

The evaluation device 180 (here termed “data analyzer”) receives the measurement results and obtains a measurement curve/profile (see also FIG. 4) for the present solvent mixture (two or more solvents). The evaluation device 180 is in communication (e.g., via the internet) with a database 170 that comprises a plurality of stored reference curves for specific system configurations. For example, the measured curve is compared with a plurality of experimental/theoretical curves, such as in a relative manner (e.g., curve shape/patterns). Hereby, the present solvent (pair) can be derived.

In the present example (based on the analytical device 10 described in FIG. 2), a restriction element 110 has been used to generate a back-pressure, which is then determined by the pressure measurement. A specific operation mode is described in the following as an example:

In this or an equivalent restriction element configuration, the fluid drive 20 is controlled to run through different composition ratios of the connected/activated channels and record the measured back-pressure. As an example, the pump 20 could run through step gradients with the channels A and B activated (0% B->20% B->40% B->60% B->80% B->100% B) or through a linear gradient (0% B->100% B in 1 min). The data analysis 180 module analyzes the data relatively, i.e., not the absolute pressures are determining the recognized/verified solvents but the relative change between different solvent compositions. For example, it is known that acetonitrile/water and methanol/water binary mixtures have characteristic pressure profiles (such as shown in FIG. 4).

The obtained data are analyzed and compared against the database 170 in which corresponding data and/or models (e.g., viscosity models of binary mixtures or machine learning models) are stored. The results are fed back to the orchestrator 70, which triggers user notification.

Optionally, the orchestrator 170 can also read out the current solvent settings from the driver to verify current setting and/or set new settings corresponding to the analysis results.

FIG. 4 shows measurement curves 115 (I-IV) that result from measurement points 111, 112 (measurement results) in a diagram, obtained by different ratios of solvent mixtures AB, in accordance with embodiments of the present disclosure.

The Y-axis in this diagram shows the value of a physical parameter, in this example the pressure (in MPa). The X-axis in this diagram shows the ratio between solvent A and solvent B in the solvent mixture AB. On the left side, there is only solvent A (water) present, while on the right side, there is only organic solvent B (e.g., acetonitrile or methanol) present. From the left side to the right side, it is illustrated that the concentration of solvent B continuously increases, thereby changing the ratio of the mixture over time. In the middle of the X-axis, it can be seen that the ratio is 1:1, i.e. similar concentration of both solvents A, B. Such a continuous ratio change over time may be realized in gradient mode of the analytical device.

It can be seen that for each specific solvent mixture ratio, at a specific temperature, a specific physical parameter (pressure) can be determined. A plurality of such measurement points (denoted here 111, 112) results in a specific measurement curve/profile 115. For example, the measurement curves of the mixture water/methanol (I, III) have a quite different shape (a large maximum in the center, like a Gaussian curve) as the measurement curves of the mixture water/acetonitrile (II, IV) (a continuous decrease). By determining/measuring a plurality of measurement points (here pressure) by the determination device 124 for different solvent mixture ratios, the measurement profile of the corresponding solvent combination/pair can be obtained.

It is important to notice that each measurement curve (I-IV) can be a fingerprint of a specific solvent pair/combination. Thus, by comparing the measurement curve with a reference curve (e.g., those shown in FIG. 4), the present solvents may be identified, thereby performing a solvent verification or solvent identification/determination. Based on this information, it can be further derived (automatically) which solvents are connected to the different channels of the analytical device, or at least check if the given solvents (in the driver) are correct.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control device or control system 70, 180 (or electronic processor-based computing device, system controller, controller, control unit, data processing unit, device for data processing, etc.) schematically depicted in FIGS. 1 and/or 3. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), or field-programmable gate arrays (FPGAs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the control device or control system 70, 180 schematically depicted in FIGS. 1 and/or 3), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

### REFERENCE SIGNS

10 Analytical device
20 Fluid drive
25 Solvent supply
27 Degasser
30 Sample separation unit
40 Sampler, sample injector
50 Detector
60 Fractionating unit
70 Data processing device, control device
100 Analytical system
101 Wash pump
102 Purge valve
103 Waste line
110 Restriction element
111 Measurement point
112 Further measurement point
115 Measurement curve
120 First pump
121 Second pump
130 Flow path
131 Bypass flow path
150 Mixing valve
160 Damper device
170 Database
180 Evaluation device

1. An analytical device for analyzing a fluidic sample, the analytical device comprising:
a fluid drive, configured to stream a first solvent and a second solvent along a flow path, such that the first solvent and the second solvent are streamed as a mixture at least during a time period;
a determination device, configured to determine a value of a physical parameter with respect to the streaming of the mixture along the flow path for at least two measurements each with a different mixing ratio of the first solvent and the second solvent, thereby determining at least two measurement results; and
an evaluation device, configured to compare the at least two determined measurement results with a reference and to derive an information associated with the first solvent and/or the second solvent based on the comparison.

2. The analytical device according to claim 1, having a configuration according to at least of:
wherein the mixture changes during the time period continuously;
wherein the mixture changes during the time period discontinuously;
wherein the mixture changes during the time period with a gradient;
wherein the mixture changes during the time period without a gradient.

3. The analytical device according to claim 1, wherein the evaluation device is configured to obtain at least a portion of the reference from a database in which the reference is stored, and to compare the determined measurement results with the database.

4. The analytical device according to claim 1, comprising at least one of the following features:
wherein the system configuration of the analytical device and the system configuration of the reference is at least partially comparable;
wherein the comparison of the determined measurement results and the reference is done in a relative manner.

5. The analytical device according to claim 1, wherein the physical parameter is at least one selected from the group consisting of: a pressure; a flow rate; a flow volume; a conductivity; a temperature; a compressibility; a viscosity; a density; a refractive index; a heat capacity; and a light absorption coefficient.

6. The analytical device according to claim 1, wherein the determination device is at least one selected from the group consisting of: a measurement device; a pressure sensor; a pressure sensor of the fluid drive; a flow sensor; a temperature sensor; a conductivity sensor; and a photodetector.

7. The analytical device according to claim 1, comprising a restriction element, arranged at least partially in the flow path, and configured to restrict the fluid stream in the flow path, thereby generating a back pressure.

8. The analytical device according to claim 7, comprising at least one of the following features:
wherein the restriction element is configured as a part of the flow path;
wherein the restriction element is configured as an additional element;
wherein the restriction element is configured as at least one selected from the group consisting of: a capillary; a channel; a conduit; a loop; and a column;
wherein the restriction element is arranged at a main flow path;
wherein the restriction element is arranged at a bypass flow path;
wherein the restriction element is arranged upstream of a chromatographic column;
wherein the restriction element is associated with at least one selected from the group consisting of: a valve; a purge valve; a sample injector; a sample loop; and an oven;
wherein the restriction element is adjustable by switching to a specific flow path.

9. The analytical device according to claim 1, comprising at least one of the following features:
a mixture portion configured to mix the first solvent and the second solvent;
a mixture portion comprising a mixer or a valve, and configured to mix the first solvent and the second solvent.

10. The analytical device according to claim 1, comprising at least one of the following features:
wherein the at least two measurement results are measurement points that form a measurement curve;
wherein the at least two measurement results are measurement points that form a measurement curve, the reference comprises a reference curve, and the evaluation device is configured to compare the measurement curve with the reference curve;
wherein the at least two measurement results are measurement points that form a measurement curve, the reference comprises a reference curve, wherein comprising a database in which the reference is stored, the evaluation device is configured to compare the measurement curve with a reference curve, in particular of the database,
wherein the evaluation device is configured to obtain a reference curve of the reference from a database in which the reference curve is stored, and to compare the determined measurement results with the database.

11. The analytical device according to claim 1, wherein at least one of the first solvent and the second solvent is known.

12. The analytical device according to claim 1, wherein the first solvent and the second solvent are unknown.

13. The analytical device according to claim 1, wherein the information comprises at least one of the following:
information related to determining the first solvent and/or the second solvent;
information related to verifying the first solvent and/or the second solvent;
information related to assigning the first solvent to a first solvent container and/or a first solvent channel;
information related to assigning the second solvent to a second solvent container and/or a second solvent channel;
information related to verifying if the first solvent is associated with a first solvent container and/or a first solvent channel;
information related to verifying if the second solvent is associated with a second solvent container and/or a second solvent channel.

14. The analytical device according to claim 1, comprising at least one of the following features:
an analytical portion configured to analyze the fluidic sample;
an analytical portion configured to analyze the fluidic sample and comprising a chromatographic column.

15. The analytical device according to claim 1, having a configuration selected from the group consisting of: a configuration forming a sample separation device; a configuration forming a fluidic chromatography device; and a configuration forming a high-performance liquid chromatography device.

16. An analytical system, comprising:
the analytical device according to claim 1; and
a database in which the reference is stored,
wherein the analytical device and the database are communicatively coupled or networked.

17. The analytical system according to claim 16, comprising at least one of the following features:
wherein the database comprises a plurality of solvent mixture data and/or a plurality of solvent mixture models;
wherein the database comprises experimental data and/or theoretical data relating to solvent mixture data and/or a plurality of solvent mixture models.

18. A method for deriving solvent-associated information for an analytical device, the method comprising:
streaming a first solvent and a second solvent along a flow path, such that the first solvent and the second solvent are streamed as a mixture at least during a time period;
determining a value of a physical parameter with respect to the streaming of the mixture along the flow path for at least two measurements each with a different mixing ratio of the first solvent and the second solvent, thereby determining at least two measurement results;
comparing the at least two determined measurement results with a reference; and
deriving the solvent-associated information based on the comparison.

19. The method according to claim 18, comprising at least one of the following features:
using the same flow path for the derivation of two or more information;
using the same flow path for a plurality of different solvents.

20. The method according to claim 18, wherein the method applies at least one determination device of the analytical device and/or is free of an additional determination device.
